(19) United States
(12) Patent Application Publication
(10) Pub. No.: US 2010/0023807 A1
(43) Pub. Date: Jan. 28, 2010

(54) TEST DEVICE AND METHOD FOR THE SOC TEST ARCHITECTURE

(75) Inventors: Ming-Shae WU, Kaohisung City (TW); Kun-Lun Luo, Hsinchu City (TW)

Correspondence Address: Wang Law Firm, Inc., 4989 Peachtree Parkway,, Suite 200, Norcross, GA, 30092, US

(73) Assignee: INDUSTRIAL TECHNOLOGY RESEARCH INSTITUTE, Chutung (TW)

(21) Appl. No.: 12/434,674

(22) Filed: May 3, 2009

(30) Foreign Application Priority Data
Jul. 23, 2008 (TW) 97127916

(51) Int. Cl. G06F 11/273; G06F 11/22

(52) U.S. Cl. 714/30; 714/32; 714/E11.148; 714/E11.171

(57) ABSTRACT

A test device for the SoC test architecture is disclosed. The device comprises plural test groups connected in parallel and a test control flag register within a controller. Each test group comprises single or plural core circuits. The test control flag register enables a set of test signals to input in one of the test groups, testing the core circuits in the test group.

### CROSS REFERENCE TO RELATED APPLICATIONS

This Application claims priority of Taiwan Patent Application No. 97127916, filed on Jul. 23, 2008, the entirety of which is incorporated by reference herein.

### TECHNICAL FIELD

The disclosure relates to a test device and method for the SoC test architecture.

### BACKGROUND

System-on-a-Chip (SoC) devices are widely used for many applications. With combining cores from different sources, the fault coverage of a core-based SoC has been decreased. Therefore, IEEE 1500 test standard, i.e. the test standard for core-based design, has been approved by the IEEE (Institute of Electrical and Electrical and Electronic Engineers) to reduce the test complexity of a SoC device, and reuse the test architecture.

FIG. 1 is a schematic view of a test wrapper for the IEEE 1500 standard. The fault coverage of a SoC device can be improved by using this test architecture.

A test wrapper conforming to IEEE 1500 standard is wrapped around a core. The test wrapper includes an n-bit wrapper instruction register (WIR) (not shown) for storing a test instruction, a 1-bit wrapper bypass register (WBY) (not shown), a wrapper boundary register (WBR) for storing test data, a serial interface layer and a set of standard wrapper serial control (WSC), wherein WIR and WBY are included in the serial interface layer. The test circuit can also access data registers inside the core for testing requirement. This type of data register is called a core data register (CDR).

The architecture of the IEEE 1149.1 standard, as shown in FIG. 2, may also be used for testing a core-based design. The IEEE 1149.1 standard is defined for testing and debugging a chip that is mounted on a printed-circuit board (PCB) thereon. The test wrapper complying with the IEEE 1149.1 standard is composed of a set of Test Access Port (TAP) test signals, a boundary scan register (BSR) connecting input/output (I/O) ports to an internal core, an instruction register (IR), a bypass register, and a TAP controller. The TAP controller is composed of a finite state machine (FSM) and a state register, as shown in FIG. 3.

A data register and corresponding test instructions can be self-defined based on the IEEE 1149.1 standard in addition to mandatory and optional instructions and registers predefined in the specification. A test process and test data paths of an integrated circuit (IC) can be controlled using the TAP controller. The IEEE 1149.1 standard can be applied to either testing on a PCB or testing and debugging on a core within a SoC.

However, when more cores are integrated into a SoC, control signals complying with the IEEE 1500 standard inside cores of respective wrappers and the total length of the test registers of the cores are linearly and multiply increased, costing much time for inputting wrapper instruction registers complying with the IEEE 1500 standard while changing test instructions is performed. Thus, a test device and method for the SoC test architecture is desirable, managing controllers of cores and saving test time.

### SUMMARY

An exemplary embodiment consistent with the invention, there is provided a test device for the SoC test architecture comprises plural test groups, an output multiplexer, and a test flag controller. Test inputs and a set of control signals of the test groups are parallel-connected, each test group is composed of one or more cores, and test inputs and test outputs of the cores in the same test group are serial-connected (i.e. the test output of a core is connected to the test input of the next core) while controls of the cores are parallel-connected. The test outputs of the test groups are connected to input ports of the output multiplexer respectively and the output of the output multiplexer serves as the test output of the SoC test architecture. A test input port is connected to the input of the test flag controller and the test inputs of the test groups. The test flag controller receives the test data from the test input port and determines which one of the test groups under test, and which cores of the test group need to be changed test instructions. Output ports of the test flag controller are connected to the control signal ports of the output multiplexer for selecting one of the test outputs of the test groups as the output of the output multiplexer, and inputted to the test groups for selecting which cores need to be changed the test instructions.

Another exemplary embodiment consistent with the invention, there is provided a test device for the SoC test architecture comprises a single test group and a test flag controller. The single test group is composed of plural cores, wherein test inputs and test outputs of the test group are serial-connected and control signals of the test group are parallel-connected. A set of output port of the test flag controller is connected to the cores of the test group and is composed of a set of plural test control flags to be inputted to the test groups for selecting which cores of the test group need to be changed the test instruction.

An exemplary embodiment consistent with the invention, there is provided a test method for the SoC test architecture comprises the following. The test architecture is composed of plural test groups which are parallel-connected, a test flag controller, and a test controller, wherein each of the test groups comprises plural cores, the test flag controller comprises a test-control flag register, and a data register of the test controller comprises a boundary scan register, a bypass register, an instruction register (IR) decoder, and an instruction register. The instruction register is programmed. A test instruction is set to the instruction register to determine whether the test input data is inputted to the test-control flag register, the boundary scan register, or the bypass register. The test-control flag register is set according to the test data received from the test input port. A core test instruction is set to the instruction register. The wrapper instruction register is programmed and a core test process is performed. Test data is transmitted to wrapper boundary registers/scan chain registers selected by the test-control flag register. The test process is terminated if the core test process has been completed.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a test wrapper for the IEEE 1500 standard;

FIG. 2 is a schematic view of a test wrapper comprising a test access port (TAP) complying with the boundary scan standard for the IEEE 1149.1 standard;

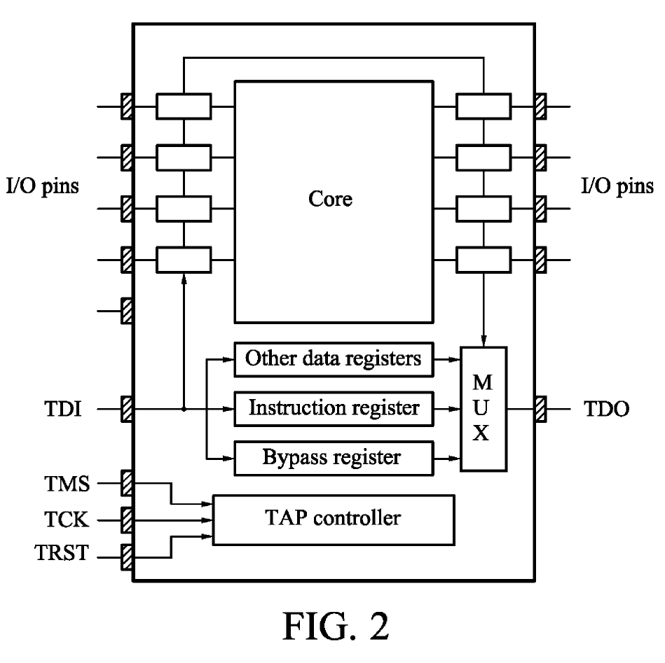

FIG. 3 is a schematic view of operation states of a TAP controller;

FIG. 4 is a schematic view the architecture of the register of a TAP controller of the exemplary embodiment consistent with the present invention;

FIG. 5 is a schematic view of a test architecture for the IEEE 1500 standard of the exemplary embodiment consistent with the present invention;

FIG. 6 is a schematic view of a serial interface layer (SIL) within a core of the exemplary embodiment consistent with the present invention;

FIG. 7 is a schematic view of a core data register within the TAP applying for parallel testing of the exemplary embodiment consistent with the present invention;

FIG. 8 is a schematic view of a wrapper circuit complying with the IEEE 1500 standard applying for parallel testing of the exemplary embodiment consistent with the present invention;

FIG. 9 is a schematic view of another embodiment of a test architecture for the IEEE 1500 standard of the exemplary embodiment consistent with the present invention;

FIG. 10 is a flowchart of a test method for the SoC test architecture of the exemplary embodiment consistent with the present invention;

FIG. 11 is a schematic view of the hybrid SoC architecture of the exemplary embodiment consistent with the present invention;

FIG. 12 is a schematic view of a TAP data register applying for the hybrid SoC architecture of the exemplary embodiment consistent with the present invention; and

FIG. 13 is a schematic view of another embodiment of a TAP data register applying for the hybrid SoC architecture of the exemplary embodiment consistent with the present invention.

### DETAILED DESCRIPTION

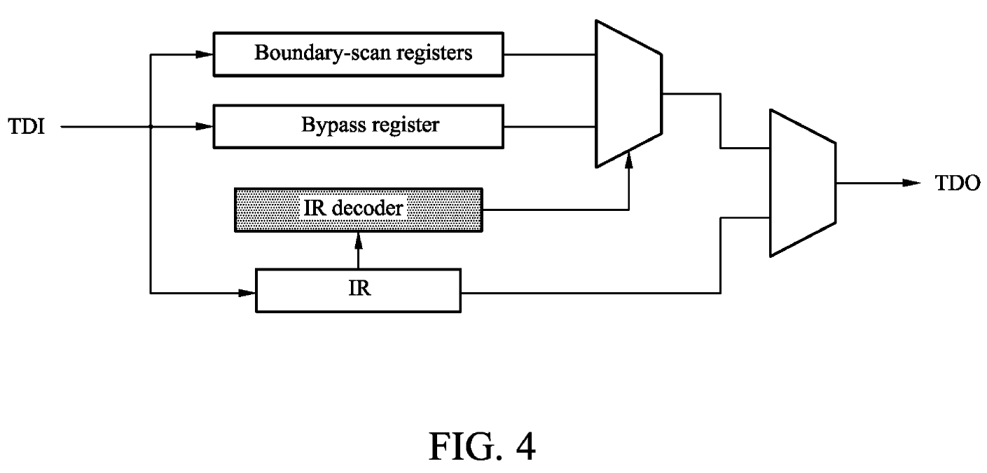

Several exemplary embodiments consistent with the invention are described with reference to FIGS. 4 through 13, which generally relate to a test device and method for the SoC test architecture. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The exemplary embodiment consistent with the invention discloses a test device and method for the SoC test architecture.

An embodiment of a test flag controller can manages wrappers complying with the IEEE 1500 and 1149.1 test standard to achieve high efficiency for a testing mechanism.

An exemplary embodiment of the method controls testing processes of the overall ICs using a FSM of a TAP complying with the boundary scan standard for the IEEE 1149.1. A new control circuit and test process can be added to a test controller so that wrappers complying with the IEEE 1500 standard can be tested in parallel without changing the FSM of the test controller. Configurable instructions for a test-control flag register and configurable test instructions for a core are added to the test controller so re-programming a core instruction register in which test instructions should be changed is allowed. Thus, under the parallel test architecture, the purpose of inputting less instructions and saving test time can be achieved.

Under the test architecture of a SoC, the Test-Data-In (TDI) port or Wrapper-Serial-Input (WSI) port/Test-Data-Out (TDO) port or the Wrapper Serial Output (WSO) port of a test wrapper complying with the IEEE 1149.1/1500 standard can be parallel- or serial-connected. Parallel connection indicates test-data input ports (TDI or WSI) of each core under test are connected to an internal test-data input port which is provided by the test controller for propagating the test-data from external test data input port (TDI) to the cores which are tested, and test-data output ports (TDO or WSO) of each core under test are respectively connected to plural internal test-data output ports which are provided by the test controller. Since there is only one external test data output (TDO), the test-data outputs from each core under test are connected to plural input ports of a multiplexer in the test controller, and the output of multiplexer is controlled by the test controller through a test instruction. Serial connection indicates each core under test provides a test-data input port (TDI or WSI) and a test-data output port (TDO or WSO), and only one test-data input port (TDI or WSI) of a core under test is connected to the internal test-data input port (TDI or WSI) of the test controller and the test-data output port of the core is connected to the test-data input port of the next core, thus serial-connecting all the cores under test one by one. Finally, the test-data output port for the last core is connected to an internal test-data output port of the test controller.

There is only one test controller in the parallel connection architecture. Since every core is tested independently, it needs a unique control circuits for the test controller to control the test inputs and test outputs (WSI/WSO) of each cores respectively. When instructions are inputted into multiple cores, under the parallel connection architecture of the test controller, cores under test (Select_Core_1, Select_Core_2, . . . ) are selected by sequentially inputting the instructions and the instructions are shifted into an instruction register (WIR) of the selected core. Thus, the testing time based on the parallel connection may not much less than that based on the serial connection, and test instructions and control circuits of the test controller may be substantially increased. In other words, the area of test hardware is increased and the manufacturing cost is also increased, then the total production cost may not be reduced. Thus, compared with the parallel connection, the serial connection is acceptable for the test architecture.

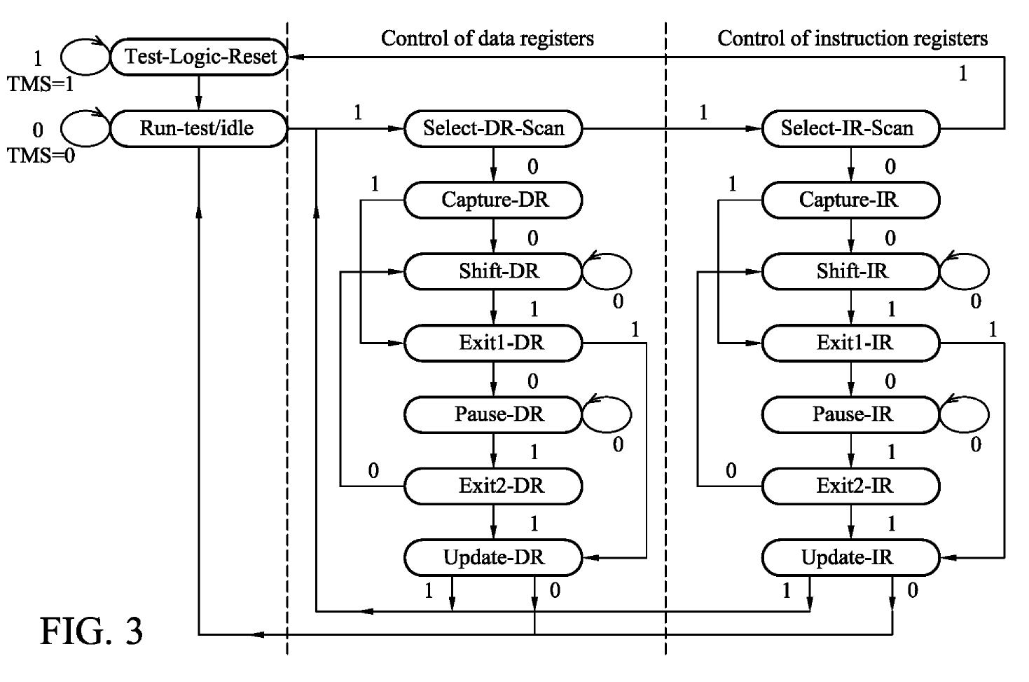

The architecture of the register of the TAP controller based on the IEEE 1149.1 standard is shown in FIG. 4. The instruction register receives data from the TDI output when TAP controller operates at the Shift-IR state. When the TAP controller operates at the Shift-DR state, the IR decoder decodes contents of the instruction register and determines a transmission path of the outputted test data. During the test process, the state of the TAP controller (as shown in FIG. 3) is converted from the Test-Logic-Reset state to the Shift-IR state (Test-Logic-Reset state→Run-test/idle state→Select-DR-Scan state→Select-IR-Scan state→Capture-IR→Shift-IR state). At the Shift-IR state, test instructions are stored in the instruction register. The state stored in the instruction register is decoded using the IR decoder when the TAP controller operates at Update-IR state, so the data from the external TDI input ports can be shifted into the boundary scan register or the bypass register, when the TAP controller operates at the Shift-DR state. After the test instruction has been shifted and updated at the Update-IR state, the state of the TAP controllers is shifted to the Shift-DR state (Shift-IR state→Exit-IR state→Update-IR state→Select-DR-Scan state→Capture-DR state→Shift-DR state) by changing the value of the TMS port, and then the test data is shifted in from the external TDI port and shifted out through the external TDO port.

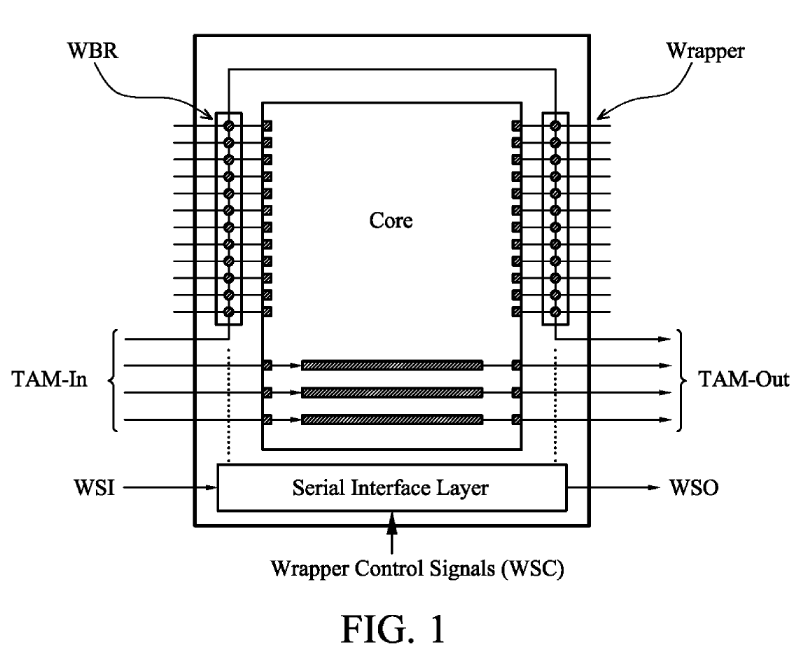

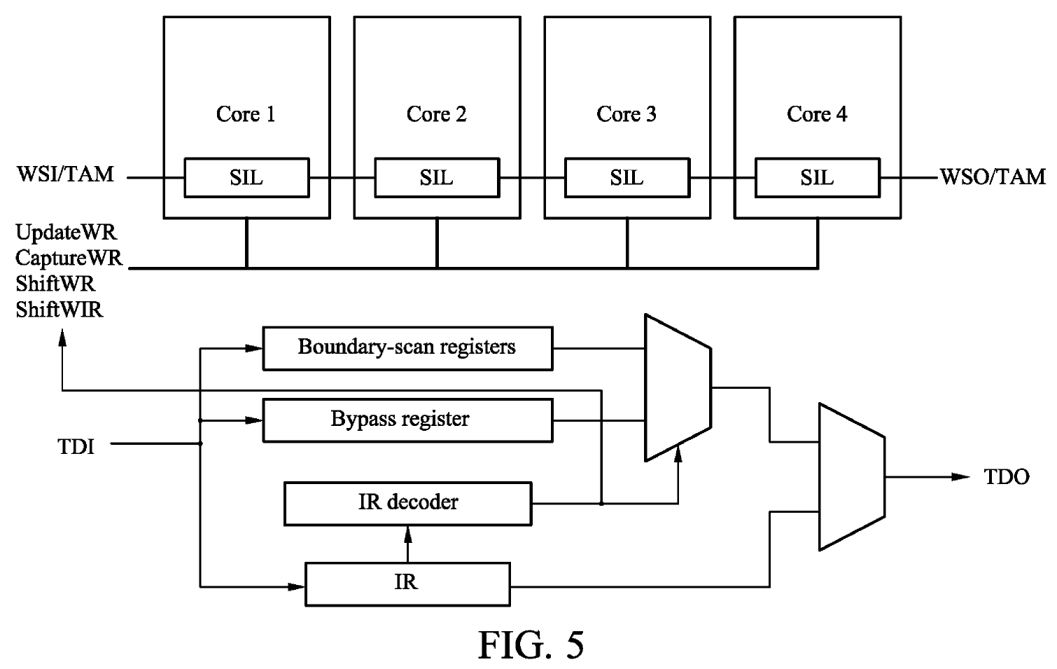

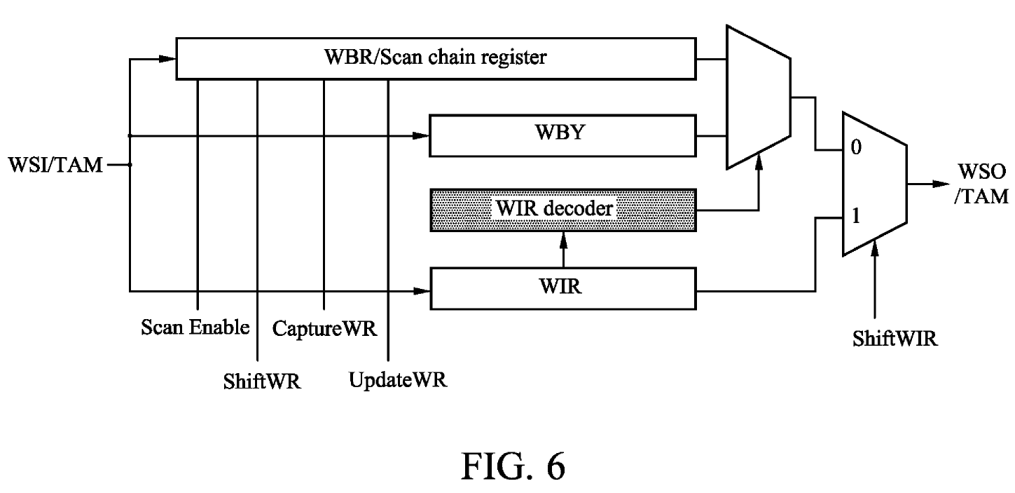

FIG. 5 is a schematic view of the test architecture for the IEEE 1500 standard of the exemplary embodiment consistent with the present invention. Under the test environment for the IEEE 1500 standard, WSI/WSO ports of each wrapped cores (as shown in FIG. 1) are serial-connected that UpdateWR, CaptureWR, ShiftWR, and ShiftWIR signals complying with the IEEE 1500 standard are generated by the TAP controller or other logic circuits or directly inputted from external ports. Note that the UpdateWR, CaptureWR, and ShiftWR signals acts like the Update-DR, Capture-DR, and Shift-DR signals complying with the IEEE 1149.1 standard. The SelectWIR signal determines whether the test instructions can be shifted from the WSI port to WIR ports of each core. Thus, an instruction code must be specified and added to the TAP controller for executing the described process. Additionally, when the specified instruction is stored in the instruction register, if the state of the TAP controller (as shown in FIG. 3) is shifted to the Update-DR state, Capture-DR state or Shift-DR state, the relative controls signals, the UpdateWR, CaptureWR, or ShiftWR are enabled respectively for testing cores. In the same clock cycle, only one of the UpdateWR, CaptureWR, and ShiftWR signals can be enabled, and the others are kept disabled. FIG. 6 is a schematic view of a serial interface layer (SIL) within a core of the exemplary embodiment consistent with the present invention, comprising a wrapper boundary register (WBR)/scan chain register, a wrapper bypass register, a WIR decoder, and a wrapper instruction register. The architecture of the serial interface layer is identical to that of the register of the TAP controller with providing similar operations. The serial interface layers are located in each core for controlling the test data paths inside the cores while the TAP controller controls test data path between the cores and the data registers of the TAP controller.

As shown in FIG. 6, when the ShiftWIR signal is represented by 1, a test instruction of a core is shifted from the WSI port to the WSO port through the WIR. When the WSI/WSO ports of the cores are serial-connected (as shown in FIG. 5), the test clock number required for shifting a test instruction into each core is identical to the total bit number of the wrapper instruction registers of all the cores. Since a SoC is composed of plural cores, a control instruction must be inputted to enable the instruction inputting process and the test controller must shift all the test instructions of all the wrapper instruction registers inside each core, regardless how many instructions of the cores need to be changed.

Thus, the time for shifting the test instructions is increased when the number of serial-connected cores is increased. However, considering power consumption when testing, only few cores are tested during the test process and other cores are set to be bypassed (IRs or WIRs are set to the BYPASS/WS_BYPASS instructions) for preventing chip damaged by overheating due to great testing power consumption during the test process. Most of the cores are still set to be bypassed, even when changing the target core that will be tested during the next test process, such that the instruction should not be updated.

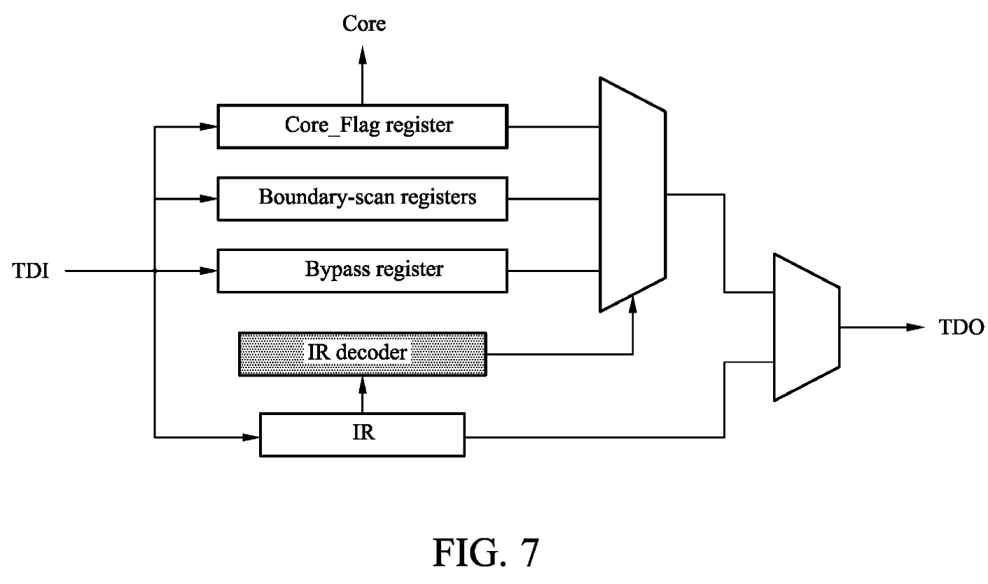

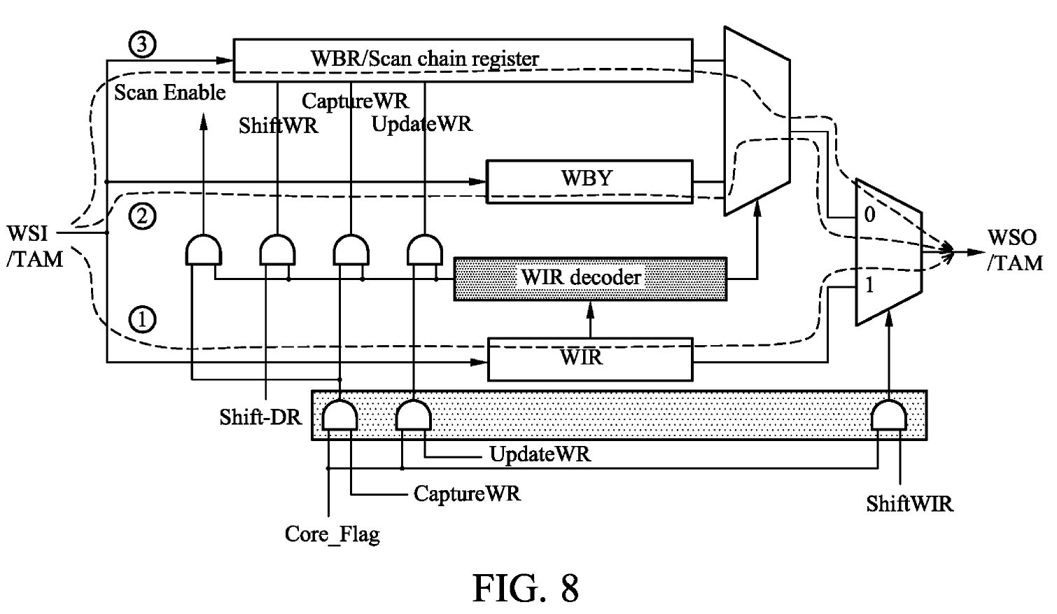

The exemplary embodiment consistent with the invention provides a method for not changing the wrapper instruction register of the core that are set to be bypassed, and rapidly updating test instructions for the cores need to be tested. FIG. 7 is a schematic view of a core data register within the TAP applying for parallel testing of the exemplary embodiment consistent with the present invention. A test-control flag register (ex. Core_Flag register) is added to the data register of the TAP controller and used for setting wrapper instruction registers of which cores should be updated. FIG. 8 is a schematic view of a wrapper circuit complying with the IEEE 1500 standard applying for parallel testing of the exemplary embodiment consistent with the present invention. If Core_Flag=1 and ShiftWIR=1, test data is shifted from the WSI port of the WIR to the WSO port (path \textcircled{1}). If Core_Flag=0, content of the wrapper instruction register is not changed and the test data path is remained (path \textcircled{2} or \textcircled{3}).

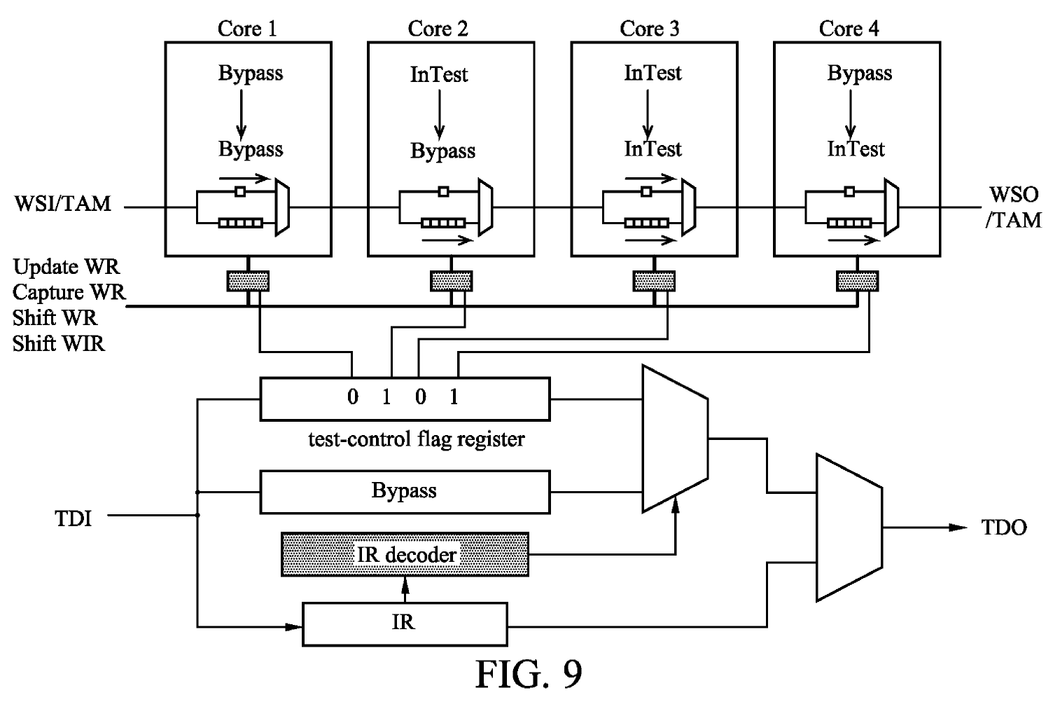

FIG. 9 is a schematic view of another embodiment of a test architecture for the IEEE 1500 standard of the present invention, comprising plural (4, for example) cores in which instructions can be shifted from WSI port by serial and displaying the test data flow. When test instructions of {Core1, Core2, Core3, Core4} are changed from {Bypass, InTest, InTest, Bypass} to {Bypass, Bypass, InTest, InTest}, since the Core1 are set to the Bypass instruction previously and formerly, the test data can be shifted using the bypass path without updating the content of the wrapper instruction register. The Core3 are set to the InTest instruction previously and formerly, the test data path can also be using the bypass path of the Core3, and keeping the instruction the same, as shown in FIG. 9. Thus, there are only 2 instructions of the cores need to be changed, and it saves the instruction shifting time.

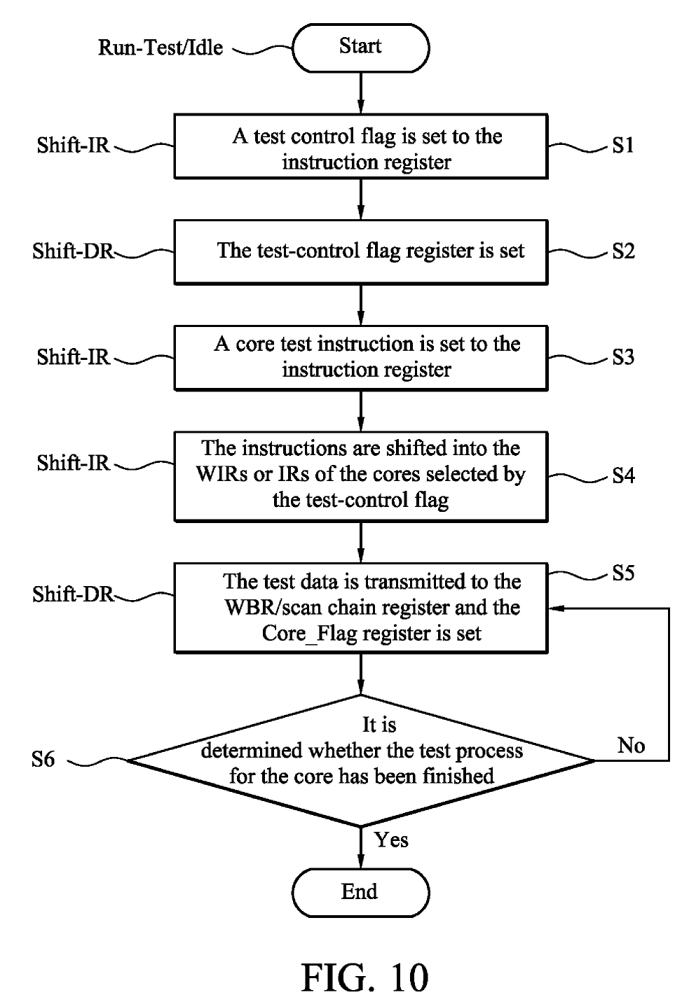

FIG. 10 is a flowchart of a test method for the SoC test architecture of the exemplary embodiment consistent with the present invention.

Referring to FIGS. 7˜9, when the test process starts, the instruction register is set to an instruction wherein the instruction sets the test data shifted from the TDI port to the test-control register and set to the cores that need to be changed the test instructions (step S1). Next, the test-control flag register is set according to the determination result (step S2), for example, as shown in FIG. 9, the test-control flag register is set to 0101, it means that the instructions of Core1 and Core3 need not to be changed in the test process next to the process that the test-control flag register is set, and when the test instructions are shifted into the test architecture, the Core1 and Core3 are bypassed, and it saves the instruction shifting time of Core1 and Core3, but it also needs some clock cycles to shift the instruction and data for the test-control flag register. If there are many cores in a SoC, then it can save a lot of testing time in shifting the test instructions. Referring to FIG. 3, the steps S1 and S2 is implemented via the Exit1-IR, Update-IR, Select-DR-Scan, and Capture-DR states. The step S2 is implemented at the Shift-DR state or the Shift-IR state that a mechanism is designed in the TAP controller so the process from the step S1 to the step S2 is implemented via the Exit1-IR, Pause-IR, Exit2-IR, and Shift-IR states, thus reducing a clock cycle.

A core test (Core_Test) instruction is set to the instruction register (step S3) and WIR instructions are set to be shifted to the wrapper instruction registers of the cores which test instructions need to be changed (step S4). Thus, if there only few WIR need to be changed, it can cave lot of test clock cycles for shifting the test instructions. The steps S3 and S4 are implemented via the Shift-IR, Exit1-IR, Update-IR, Select-DR-Scan, Select-IR-Scan, Capture-IR, and Shift-IR states or via the Shift-IR, Exit1-IR, Pause-IR, Exit2-IR, and Shift-IR states.

The test data is shifted to the wrapper boundary register (WBR)/scan chain register shown in FIG. 8 and the Core_Flag register is set (step S5). It is determined whether the test process for the core has been finished (step S6). If the test process has been finished, the test process terminates, and, if not, the test process proceeds to the step S5. Referring to FIG. 8, the test data is shifted from the WSI/TAM port while the Core_Flag register receive new contents from the TDI port, so that the UpdateWR or CaptureWR instruction is implemented to respective cores using the mechanism shown in FIG. 8 when the TAP controller operates at the Update-DR or Capture-DR state. Thus, only the content of the Core_Flag register must be changed so the Shift-DR, Capture-DR, and Update-DR signals sent by the TAP controller can be shared by the whole cores.

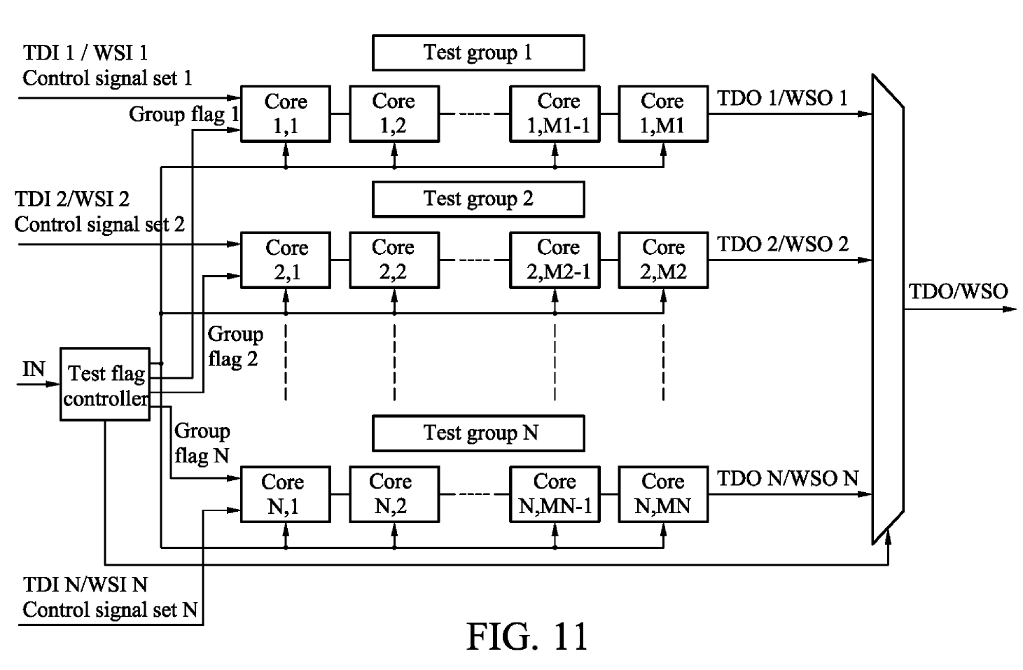

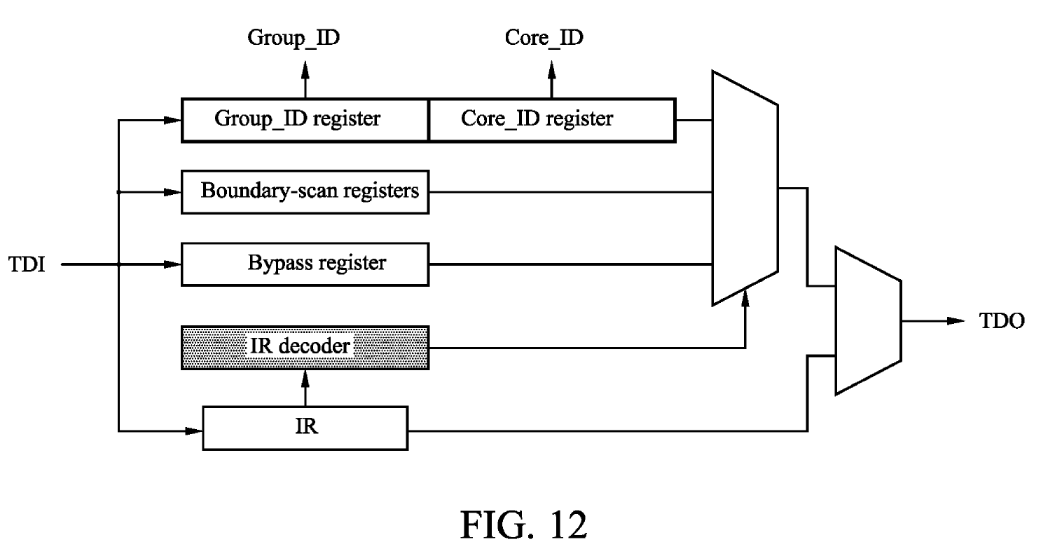

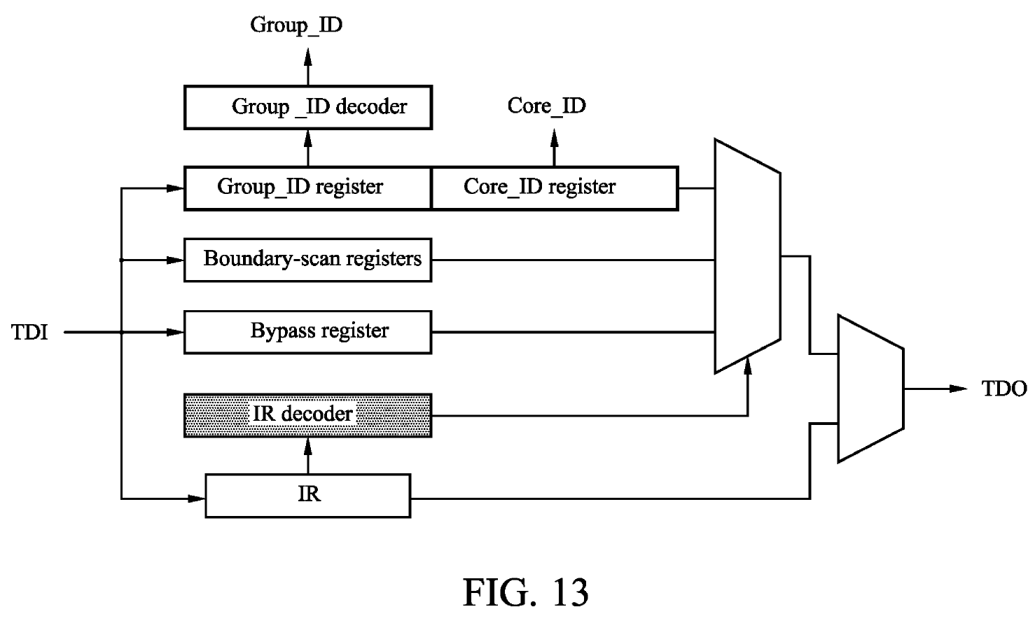

When many cores are included in the system chip, if the cores are serial-connected for testing, the test time may be long. Thus, all the cores are grouped that identical groups are serial-connected for testing while different groups are parallel-connected and tested at different time segments so the number of cores which are serial-connected can be reduced, as shown in FIG. 11. FIG. 12 is a schematic view of a TAP data register applying for the hybrid SoC architecture of the exemplary embodiment consistent with the present invention. FIG. 13 is a schematic view of another embodiment of a TAP data register applying for the hybrid SoC architecture of the present invention. The group identification register (Group_ID Register) and core identification register (Core_ID Register) shown in FIGS. 12 and 13 are used for selected group targets under test, difference of which is that the group identification register is un-decoded, such that the length of the group identification signal is identical to the number of the groups. Relatively, the group identification register is decoded so the length thereof is less than that of the group identification signal, resulting in less input time. Core_ID register and Core_ID signal are used to select the cores which instructions need to be changed during the test process.

For example, If there are 4 test groups in the SoC, and 8 cores in each group, then it needs a 2-bit group identification register (stands for group 0˜group 3) and a 8-bit core identification register (every core has its own bit). When the 5th core and 8th core of test group 3 need to be tested, the group identification register is set to 11, and the core identification register is set to 00001001. Thus it only needs to shift 2 instructions into these 2 cores and bypasses the other 6 cores.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A test device for the SoC test architecture, comprising:
plural test groups, wherein test inputs and a set of control signals of the test groups are parallel-connected, each test group is composed of one of plural cores, and test inputs and test outputs of the cores are serial-connected while controls of the cores are parallel-connected;
an output multiplexer, wherein the test outputs of the test groups are connected to input ports of the output multiplexer respectively; and
a test flag controller, wherein the input of the test flag controller is parallel connected to the test inputs, and controls the control signal ports of the output multiplexer for selecting one of the test groups wherein the test output of the selected test group serves as the output port of the output multiplexer, and is composed of a set of plural test control flags to be inputted to the test groups for selecting the cores of the selected test group as the cores under test.

2. The test device for the SoC test architecture as claimed in claim 1, wherein the test control flag comprises:
plural group flags, connected to the control signal ports of the output multiplexer to enable one of the test groups to be tested; and
a core flag set, simultaneously inputted to each of the test groups, wherein the core flag set comprises core flags comprising plural bits which are respectively inputted to different cores of the test groups.

3. The test device for the SoC test architecture as claimed in claim 1, wherein the test flag controller further comprises:
a test-control flag register; and
a group identification decoder, wherein input ports of the group identification decoder are connected to a portion of outputs of the test-control flag register.

4. The test device for the SoC test architecture as claimed in claim 3, wherein the test-control flag register is composed of a group identification register comprising one or plural bits and a core flag register comprising plural bits, the outputs of the group identification register serves as inputs of the group identification decoder, and outputs of the group identification decoder which are connected to the control signal ports of the output multiplexer, represents the test group identification, and every bit of the core flag register represents identification of a core of a test group.

5. The test device for the SoC test architecture as claimed in claim 1, wherein each test group is composed of plural test wrappers complying with the IEEE 1500 and/or 1149.1 standard which are serial connected.

6. The test device for the SoC test architecture as claimed in claim 1, wherein plural instructions are inputted to wrapper instruction registers or instruction registers of some selected cores of the test groups under the serial-connected architecture.

7. The test device for the SoC test architecture as claimed in claim 1, wherein the serial-connected cores within the single test group under the parallel-connected architecture of the test groups are tested by using plural instructions.

8. The test device for the SoC test architecture as claimed in claim 1, wherein the test-control flag register enables plural instructions to be inputted to wrapper instruction registers or instruction registers of a portion of cores within one of the test groups under the serial-connected architecture of the cores of each of the test groups, enables an instruction to be inputted to a wrapper instruction register or an instruction register of one of the cores within one of the test groups under the serial-connected architecture, or enables a controller to input instructions to wrapper instruction registers or instruction registers of the cores within one of the test groups under a hybrid test architecture composed of the parallel-connected architecture of the test groups and the serial-connected architecture of the cores of each of the test groups, or enables a controller to input an instruction to an wrapper instruction register or an instruction register of one of the cores within one of the test groups under a hybrid test architecture composed of the parallel-connected architecture of the test groups and the serial-connected architecture of the cores of each of the test groups.

9. A test device for the SoC test architecture, comprising:
a single test group, composed of a test inputs port, a test output port, plural cores, wherein test inputs and test outputs of cores within the test group are serial-connected and control signals of the test group are parallel-connected; and
a test flag controller, wherein an input of the test flag controller is parallel-connected to the test input of the test group and is composed of a set of plural test control flags to be inputted to the test groups for selecting the cores of the test group which instructions need to be changed.

10. The test device for the SoC test architecture as claimed in claim 9, wherein the test flag controller is composed of a test-control flag register comprising plural bits.

11. The test device for the SoC test architecture as claimed in claim 9, wherein each core of the test group is composed of a test wrapper complying with the IEEE 1500 or 1149.1 standard which are serial-connected.

12. The test device for the SoC test architecture as claimed in claim 9, wherein plural instructions are inputted to wrapper instruction registers or instruction registers of some cores of the test group selected by the test flag controller under the serial-connected architecture.

13. The test device for the SoC test architecture as claimed in claim 9, wherein the test-control flag register enables plural instructions to be inputted to a wrapper instruction registers or instruction registers of a portion of some cores within one of the test groups under the serial-connected architecture of the cores of the test group, enables an instruction to be inputted to a wrapper instruction register or an instruction register of one of the cores within the test groups under the serial-connected architecture, enables a controller to input plural instructions to a wrapper instruction registers or an instruction registers of some cores within the test group under serial-connected architecture of the cores of the test group, or enables a controller to input an instruction to a wrapper instruction register of one of the cores within the test groups under the serial-connected architecture of the cores of the test group.

14. The test device for the SoC test architecture as claimed in claim 9, wherein the test input and a set of control signals are respectively inputted to a single test group, based on the value stored in the test-control flag register, to test the cores of the test group.

15. A test method for the SoC test architecture, wherein the test architecture is composed of plural test groups which is parallel-connected and a test controller, wherein each of the test groups comprises plural cores, and the test controller comprises a test-control flag register, a boundary scan register, a bypass register, an instruction register (IR) decoder, and an instruction register, comprising:
programming the instruction register;
setting an instruction to instruction register to determine whether test input data are inputted to the test-control flag register, the boundary scan register, or the bypass register;
setting the test-control flag register by shifting the test input data according to the determination result;
setting a core test instruction to the instruction register;
programming the wrapper instruction registers and performing a core test process;
shifting test data to wrapper boundary registers and/or scan chain registers;
determining whether the core test process has been completed; and
terminating the test process if the core test process has been completed or repeatedly shifting the test data.

16. The test method for the SoC test architecture as claimed in claim 15, wherein the step of setting the instruction register for setting the test control flag are sequentially performed based on plural Shift-IR state and an Exit1-IR state.

17. The test method for the SoC test architecture as claimed in claim 16, wherein the step of setting the test control flag to the test-control flag register are performed based on plural Shift-DR states and an Exit1-DR state.

18. The test method for the SoC test architecture as claimed in claim 15, wherein the step of setting the core test instruction to the instruction register and performing the core test process are sequentially performed based on plural Shift-IR state, an Exit1-IR state, a Update-IR state, a Select-DR-Scan state, a Select-IR-Scan state, a Capture-IR state, and the Shift-IR states or based on plural Shift-IR state, an Exit1-IR state, a Pause-IR state, a Exit2-IR state, and the Shift-IR state.

19. The test method for the SoC test architecture as claimed in claim 15, further comprising:
the instruction register receiving the input signal from a test-data input port;
the instruction register updating the instruction;
IR decoder decoding the input signal and determining a test data path of the input signal according to the decoding result while the test controller operates at Shift-DR states;
during the test process, shifting the state of the test controller to a Shift-IR state by changing the value of a test mode select signal;
under the Shift-IR state, storing a test instruction to the instruction register via the test-data input port, wherein the value of the test instruction is decoded by the IR decoder and set so that test data inputted from the test-data input port is shifted into the boundary scan register or the bypass register when a test process is performed; and
shifting the state of the test controller from the Shift-IR state to the Shift-DR state by changing the value of a test mode select signal, when the input of the test instruction has been completed, and inputting the test data.
